(19) United States
(12) Patent Application Publication
(10) Pub. No.: US 2023/0136551 A1
(43) Pub. Date: May 4, 2023

(54) A COMPUTER IMPLEMENTED SYSTEM AND METHOD FOR GENERATING MULTIPLE MEDIA CREATIONS

(71) Applicant: Vobium Technologies Pvt. Ltd., Mumbi (IN)

(72) Inventors: Vikram Parmar, Mumbai (IN); Dinesh Parmar, Mumbai (IN); Mihir Parmar, Mumbai (IN)

(21) Appl. No.: 17/910,555

(22) PCT Filed: Mar. 12, 2021
(86) PCT No.: PCT/IB2021/052078

§ 371 Date: Sep. 9, 2022

(30) Foreign Application Priority Data
Mar. 12, 2020 (IN) 202021010696

(51) Int. Cl. G06T 11/60; G11B 27/031

(52) U.S. Cl. CPC G06T 11/60; G11B 27/031; G06T 2200/24

(57) ABSTRACT

The present invention relates to a computer implemented system and method for generating multiple media creations. The system is able to generate and display multiple variations of media content and display to the user. The system displays multiple outputs by adding one or more types of elements or by using one or more types of manipulations to the media content. A user device receives one or more inputs from a user. A processing engine incorporates a database, a selection module, and a generation module. The database stores a plurality of pre-defined elements, media filters, user's media content and a plurality of other filters and effects. The selection module receives the inputs and selects at least one media content from one or more sources. The generation module combines one or more pre-defined elements of media filters with the selected media content, and generates one or more creations of the selected media content.

### TECHNICAL FIELD

The present disclosure relates generally to computer implemented systems and methods for generating multiple media creations.

### BACKGROUND ART

Conventionally, a user can view effects, templates, or filters on media content, for example on an image or on a video, only one at a time. Each effect/template/filter is presented generally in an icon format or a sample format, and the user has to navigate the various icons or samples manually one at a time to change the effect/template/filter. The user does not get to see all the various creations directly together. Unless, the user clicks on the various effects/templates/filters icons, the user cannot come to know how that effect/template/filter looks on an image or video. However, it is very cumbersome for the user to select one template at a time and insert a photo or video into it. For example, a conventional system such as SnapChat® renders one output at a time. In PicsArt®, a user can apply one filter at a time with a preview of one effect. Further, in a conventional image editing system, the user has to create an output by clicking on an icon from a series of icons of various filters, and then see the final creation, which takes additional effort. In Instagram®, SnapChat®, Canva®, these conventional systems present the Community Generated Filters or Lenses or Templates as samples in a feed. However, these are not shown as a final output with the user's media content embedded into them.

In conventional systems, firstly, a system displays templates without media content embedded into it. The user has to manually choose and opens at least one template from the pre-defined templates for adding the media content. Thereafter, the user has to manually insert his media content into at least one chosen template, and the user can see the media content embedded in the template as a single output. Further, in conventional systems, a user has to click on a media content or select the media content from a locally stored media gallery in a user device. The user clicks on a single filter icon, and he can see a single output with the filter applied. The user may click on different filter icons/thumbnails one by one to change the output. Additionally, the conventional systems display multiple outputs of the same media content by using only one type of manipulation or by adding only one type of element.

Hence, there is a need of systems and methods, which solves the above defined problems, and allows a user to see the media content quickly and effortlessly in a plurality of creations shown as multiple outputs in a feed. This is similar to virtual design try-ons and makes selecting the creation easier. Additionally, the systems and methods display multiple outputs by adding one or more types of elements or by using one or more types of manipulations to the media content.

### SUMMARY

This summary is provided to introduce concepts related to a computer implemented system and method for generating multiple media creations. This summary is neither intended to identify essential features of the present invention nor is it intended for use in determining or limiting the scope of the present invention.

For example, various embodiments herein may include one or more systems and methods for generating multiple media creations are provided. In one of the embodiments, a method for generating multiple media creations includes a step of receiving, by a user device, one or more inputs from a user. The method includes a step of storing, a plurality of pre-defined elements, media filters, user's media content and a plurality of other filters. The method includes a step of selecting, by a selection module, at least one media content from one or more sources. The method includes a step of combining, by a generation module, one or more pre-defined elements of media filters with the selected media content. The method includes a step of generating, by the generation module, one or more creations of the selected media content.

In another embodiment, a computer implemented system for generating multiple media creations includes a user device and a processing engine. The user device is configured to receive one or more inputs from a user. The processing engine includes a database, a selection module, and a generation module. The database is configured to store a plurality of pre-defined elements, media filters, user's media content and a plurality of other filters and effects. The selection module is configured to receive the inputs and select at least one media content from one or more sources. The generation module is configured to combine one or more pre-defined elements of media filters with the selected media content, and generate one or more creations of the selected media content.

### BRIEF DESCRIPTION OF ACCOMPANYING DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1 illustrates a block diagram depicting a computer implemented system for generating multiple media creations, according to an exemplary implementation of the present invention.

FIG. 2 illustrates a schematic diagram depicting a system architecture of FIG. 1, according to an exemplary implementation of the present invention.

FIGS. 3A & 3B illustrate a schematic diagram depicting a workflow of the system for generating multiple media creations of FIG. 1, according to an exemplary implementation of the present invention.

FIG. 4 illustrates a schematic diagram depicting selection of media content, according to an exemplary implementation of the present invention.

FIG. 5 illustrates a schematic diagram depicting automatically selecting media content from one or more sources, according to an exemplary implementation of the present invention.

FIG. 6 illustrates a schematic diagram depicting creation of media filter creation, according to an exemplary implementation of the present invention.

FIG. 7 illustrates a schematic diagram depicting fetching of media filters, according to an exemplary implementation of the present invention.

FIG. 8 illustrates a flow diagram depicting an example for generating multiple media creations, according to an exemplary implementation of the present invention.

FIG. 9 illustrates a flow diagram depicting a method for generating multiple media creations, according to an exemplary implementation of the present invention.

FIGS. 10a-10d illustrate use case scenarios depicting generation of multiple media creations, according to an exemplary implementation of the present invention.

It should be appreciated by those skilled in the art that any block diagrams herein represent conceptual views of illustrative systems embodying the principles of the present invention. Similarly, it will be appreciated that any flowcharts, flow diagrams, and the like represent various processes which may be substantially represented in computer readable medium and so executed by a computer or processor, whether or not such computer or processor is explicitly shown.

### DETAILED DESCRIPTION

In the following description, for the purpose of explanation, specific details are set forth in order to provide an understanding of the present invention. It will be apparent, however, to one skilled in the art that the present invention may be practiced without these details. One skilled in the art will recognize that embodiments of the present invention, some of which are described below, may be incorporated into a number of systems.

The various embodiments of the present invention provide a computer implemented system and method for generating multiple media creations. Furthermore, connections between components and/or modules within the figures are not intended to be limited to direct connections. Rather, these components and modules may be modified, re-formatted or otherwise changed by intermediary components and modules.

References in the present invention to “one embodiment” or “an embodiment” mean that a particular feature, structure, characteristic, or function described in connection with the embodiment is included in at least one embodiment of the invention. The appearances of the phrase “in one embodiment” in various places in the specification are not necessarily all referring to the same embodiment.

In one of the embodiments, a method for generating multiple media creations includes a step of receiving, by a user device, one or more inputs from a user. The method includes a step of storing, a plurality of pre-defined elements, media filters, user's media content and a plurality of other filters. The method includes a step of selecting, by a selection module, at least one media content from one or more sources. The method includes a step of combining, by a generation module, one or more pre-defined elements of media filters with the selected media content. The method includes a step of generating, by the generation module, one or more creations of the selected media content.

In another implementation, the step of generating the one or more creations of the selected media content further includes a step of creating, by a filtering module, a media filter based on one or more pre-defined elements or a combination of multiple elements of pre-determined types. The method includes a step of manipulating, by a manipulation module, the selected media content by using at least one manipulation technique. The method includes a step of embedding, by a creation module, the created media filter with the manipulated content. The method includes a step of creating, by the creation module, one or more creations of the selected media content.

In another implementation, the step of creating the media filter further includes a step of generating an automatic media filter by combining suitable elements of various types using a media filter generation technique.

In another implementation, the step of creating the media filter further includes a step of generating a personalized media filter based on user's preference.

In another implementation, the method includes a step of transmitting, by a communication module, the generated creations to the user device for displaying the generated creations as multiple outputs to the user.

In another implementation, the method includes a step of personalizing, by a personalization module, the creations for the user based on the contextual data.

In another implementation, the contextual data includes a theme or a category of the media filter, size of the creations, element types, types of media filters, manipulated media content, and popularity and trending.

In another implementation, the one or more sources include public profiles of said user, social media websites, local storage of the user device.

In another implementation, the media content includes images and videos.

In another embodiment, a computer implemented system for generating multiple media creations includes a user device and a processing engine. The user device is configured to receive one or more inputs from a user. The processing engine includes a database, a selection module, and a generation module. The database is configured to store a plurality of pre-defined elements, media filters, user's media content and a plurality of other filters and effects. The selection module is configured to receive the inputs and select at least one media content from one or more sources. The generation module is configured to combine one or more pre-defined elements of media filters with the selected media content, and generate one or more creations of the selected media content.

In another implementation, the generation module includes a filtering module, a manipulation module, and a creation module. The filtering module is configured to create a media filter based on one or more pre-defined elements stored in the database or a combination of multiple elements of pre-determined types. The manipulation module is configured to manipulate the selected media content by using at least one manipulation technique. The creation module is configured to embed the created media filter with the manipulated content, and create one or more creations of the selected media content.

In another implementation, the filtering module is configured to generate an automatic media filter by combining suitable elements of various types using a media filter generation technique.

In another implementation, the filtering module is configured to generate a personalized media filter based on user's preference.

In another implementation, the system includes a communication module, which is configured to transmit the generated creations to the user device to display the generated creations as multiple outputs to the user.

In another implementation, the system includes a personalization module, which is configured to personalize the creations for the user based on the contextual data.

In another embodiment, a program storage device readable by a machine is taught, tangibly embodying a program of instructions executable by the machine to perform the method steps for generating multiple media creations, said method steps comprising: receiving, by a user device, one or more inputs from a user; storing, in a database, a plurality of pre-defined elements, media filters, user's media content, and a plurality of other filters; selecting, by a selection module, at least one media content from one or more sources; combining, by a generation module, one or more pre-defined elements of media filters with said selected media content; and generating, by said generation module, one or more creations of the selected media content.

In an exemplary embodiment, a computer implemented system and method for generating multiple media creations is configured to generate a plurality of creations by using media content (for example an image or a video) and display the generated creations in a simple feed. These pluralities of creations are generated by combining the media content with single or a combination of multiple media filters, templates, and elements. The system automatically selects single or multiple media content from various sources over a network or from a local storage unit. The system renders the plurality of creations in a simple feed (for example in a grid form), thus the user can keep scrolling to see all the multiple creations together in a single view. By using the system, the user does not have to make any extra effort to generate various creations. The user also does not need to keep clicking on various pre-defined filter icons or template icons or samples to see the next creation.

In an exemplary embodiment, the system is able to generate and display multiple variations of the same media content and display to the user.

In an exemplary embodiment, the system is able to generate and display multiple variations of the multiple media content and display to the user.

In another exemplary embodiment, the system is configured to render N number of final outputs with various filters/template/effects applied to the media content in each output. In one embodiment, each template is presented as a final output with the user media content embedded into them.

In another exemplary embodiment, the system is configured to allow a user to see his media content quickly and effortlessly in a plurality of creations shown as multiple outputs in one feed. This is similar to virtual design try-ons and makes selecting the perfect creation easier.

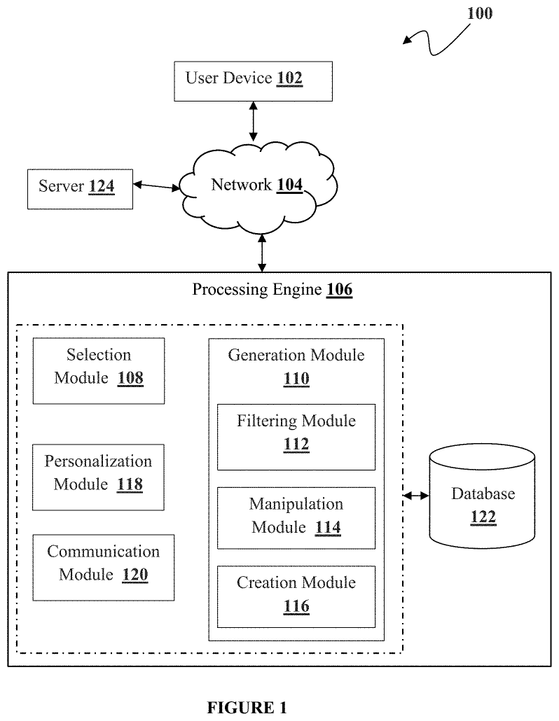

FIG. 1 illustrates a block diagram depicting a computer implemented system for generating multiple media creations, according to an exemplary implementation of the present invention.

A computer implemented system for generating multiple media creations (hereinafter referred to as “system”) (100) includes a user device (102), a network (104), a processing engine (106), and a server (124).

In an embodiment, the system (100) includes a memory and a processor (not shown in figures). The memory is configured to store pre-determined rules related to media content processing. In an embodiment, the memory includes any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory also includes a cache memory to work with the system (100) more effectively.

The processor is configured to cooperate with the memory to receive the pre-determined rules related to processing of media content. The processor is further configured to generate system processing commands. In an embodiment, the processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch the pre-determined rules from the memory and execute different modules of the system (100).

In an embodiment, the user device (102) can include, but is not limited to, a mobile device, a laptop, a personal computer, a tablet, other similar devices, and any combinations thereof. The user device (102) is associated with a user. In an embodiment, the system (100) includes a plurality of user devices which are associated with the user or multiple users.

The processing engine (106) is configured to communicatively coupled with the user device (102) via the network (104). In an embodiment, the network (104) includes wired or wireless networks. Examples of the wired networks include a Wide Area Network (WAN) or a Local Area Network (LAN), a client-server network, a peer-to-peer network, and so forth. Examples of the wireless networks include Wi-Fi, a Global System for Mobile communications (GSM) network, and a General Packet Radio Service (GPRS) network, an enhanced data GSM environment (EDGE) network, 802.5 communication networks, Code Division Multiple Access (CDMA) networks, or Bluetooth networks.

The processing engine (106) includes a selection module (108), a generation module (110), and a database (122). The processing engine (106) further includes a personalization module (118) and a communication module (120).

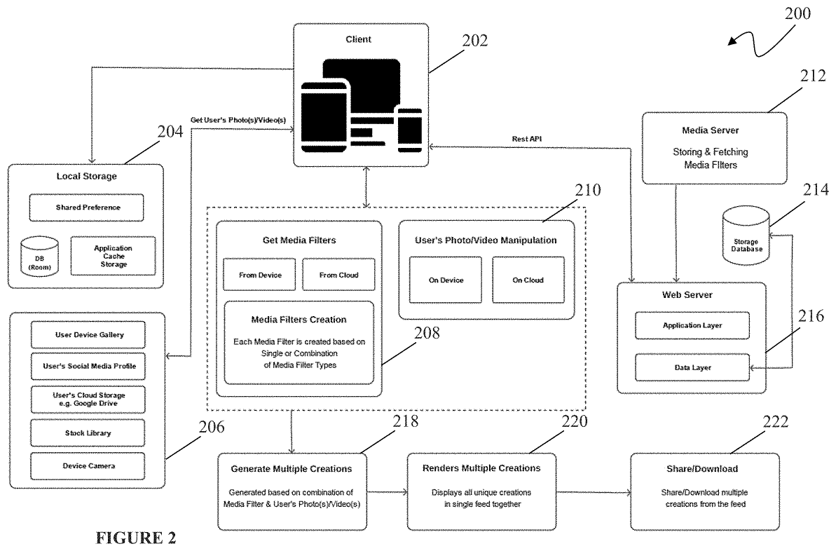

In an exemplary embodiment, the selection module (108), the generation module (110), the personalization module (118), the communication module (120), and the database (122), can be implemented on the server (124) or the user device (102). In an embodiment, the server (124) can be a media server (as shown in FIG. 2) configured to fetch media filters from one or more sources.

The selection module (108) is configured to receive user inputs and select at least one media content from one or more sources. The sources can include social media websites, photo galleries, and the like. In an embodiment, the selection module (108) is configured to select at least one media content from the user device (102) which is associated with the user. In an embodiment, the media content can include, but is not limited to, images and videos. In an embodiment, the selection module (108) is configured to select the media content, which is manually selected by the user, a real-time feed based on live camera device streaming, and/or by randomly selecting the media content from the various sources.

The generation module (110) is configured to combine one or more pre-defined elements of media filters with the selected media content, and generate one or more creations. In an embodiment, the generation module (110) includes a filtering module (112), a manipulation module (114), and a creation module (116).

The filtering module (112) is configured to create a media filter based on one or more pre-defined elements stored in the database (122) or a combination of multiple elements of various types. The media filter element types include, but are not limited to, backgrounds, animations, video effects and music, face filters, quotes & texts, doodles, photo effects, jokes, stickers, horoscope, frames, overlays, and other additional elements, ingredients, and properties.

In an embodiment, the database (122) is configured to store pre-defined elements, automatic media filters, personalized media filters, user's media content and a plurality of filters and effects. The pre-defined media filters are hand-crafted by combining the suitable elements of various types. This could also be used to create event based media filters (for example, Halloween, etc.). The automatic media filters are dynamically created by combining suitable elements of various types using a smart media filter generation technique. The technique creates the best media filters based on which elements look good together. The personalized media filters are dynamically created based on user's preferences. This could be a manual choice provided by a user, or recommendation on basis of topics/categories they follow or based on their history of likes, favorites, shared, downloaded, etc., or based on photo/video analysis such as emotions, gender, people, animals, etc. In an embodiment, each media filter is created based on single or combination of media filter types.

In another embodiment, the database (122) can be implemented as enterprise database, remote database, local database, a media server, a storage database, and the like. The database (122) can be located within the vicinity of the processing engine (106) or can be located at different geographic locations as compared to that of the processing engine (106). Further, the database (122) may themselves be located either within the vicinity of each other or may be located at different geographic locations. Furthermore, the database (122) can be implemented inside the server (122), and the server (122) can be implemented as a single database.

The manipulation module (114) is configured to manipulate the selected media content by using at least one manipulation technique. The manipulation technique includes, but is not limited to, an image/video segmentation technique, a style transfer technique, Region of Interest (RoI) detection and smart cropping (based on human, pet, objects, etc.), face recognition, hair and costumes segmentation for color changing, image and video effects, beautification, pose estimation, caricature or cartoon creation, Augmented Reality (AR) technique, mirror effects, image cloning, face detection, face landmarks, face tracking, face attributes, AR sticker, face comparing, face searching, dense facial landmarks, facial landmark trigger, emotion recognition, beauty score, gaze estimation, three-dimensional face model reconstruction, human body recognition, body detection, skeleton detection, body outlining, body attributes, gesture recognition, face merging, text recognition, image recognition, photo album clustering, makeup, hairstyling, filters & effects, skin smoothing, face shaping, face swapping, expression recognition, face fun bulge, body reshaping, virtual avatar, video effects, morphing, virtual background, augmented beauty, face AI (Emotions & Attention; Gender, Age, Ethnicity; Identification), Try On, Blending, Cutout, PIP, Spiral/Swirls, Animation Stickers, Collage Creation, GIFs, Face Fit or Face Mask, image slicing, reflection/shadow, silhouette, doodle, sketch, face painting, or dispersion.

The creation module (116) is configured to embed the created media filter with the manipulated content, and is further configured to create one or more creations of the selected media content.

The communication module (120) is configured to transmit the generated creations to the user device (102) to display the creations as multiple outputs to the user by using a display unit (not shown in a figure). In an exemplary embodiment, the creation module (120) is configured to help in displaying the one or more creations and the display unit of the user device (102) displays all outputs in a continuous feed. In an embodiment, the feed is in the form of horizontal or vertical, or can be in single or multiple grid columns. In another embodiment, the creations can be of different sizes.

The personalization module (118) is configured to personalize the creations for the user based on the contextual data. In an embodiment, the personalization module (118) is configured to customize or provide preferences directly from the feed which get applied directly to multiple outputs. In an embodiment, the contextual data can include, but is not limited to, a theme or a category of the media filter, size of the creations, element types, types of media filters, manipulated media content, and popularity and trending.

In an embodiment, the user device (102) can quickly download or share the creations as multiple outputs directly from the feed, and store the outputs in the local storage unit (i.e., the user device storage unit) or store the outputs on a cloud server (not shown in a figure) in a user's account. In an embodiment, the user can also select a single creation, which then opens in a full view mode, and then the user can customize each and every single aspect of the creation. Thereafter, the user can quickly share or download the modified creation on the feed.

FIG. 2 illustrates a schematic diagram depicting a system architecture (200) of FIG. 1, according to an exemplary implementation of the present invention.

In an exemplary embodiment, a client (202) is configured to fetch the data from a local storage (204). In an embodiment, the client (202) can be a user device (102) associated with a user of FIG. 1. The local storage (204) is configured to store media content of the user and to store the cached media filters. The local storage (204) can include a shared preference, a database (DB) room, and an application cache storage. The client (202) can also fetch the media content from various sources (206) such as, but are not limited to, a user device gallery, user's social media profile, user's cloud storage (e.g. Google® Drive), a stock library, and a device camera. In an embodiment, the selection module (108) is configured to receive the fetched media content from the client (202) as inputs and select at least one media content from the sources. The client (202) then gets media filters (208) and manipulated media content (210) from the processing engine (106) of FIG. 1. In an embodiment, the client (202) can get media filters (208) either from a device, a cloud, or a generation module (110), where each media filter is created based on single or combination of media filter types. In an embodiment, the client (202) can get manipulated media content (210) either from a device or a cloud. In an embodiment, at a block (218), the processing engine (106) of FIG. 1 is configured to generate multiple creations based on combination of media filters and user's media content (photos/videos, etc.). Based on the multiple creations, the user device (102) displays the multiple creations. In an embodiment, the user device (102) displays all unique creations in a single feed together, as shown at a block (220). Thereafter, the user can share/download the multiple creations from the feed, as shown at a block (222). In an embodiment, the system architecture (200) includes a media server (212), which is configured to fetch media filters from a web server (216). The web server (216) includes an application layer and a data layer, which is configured to store the media filters in a storage database (214).

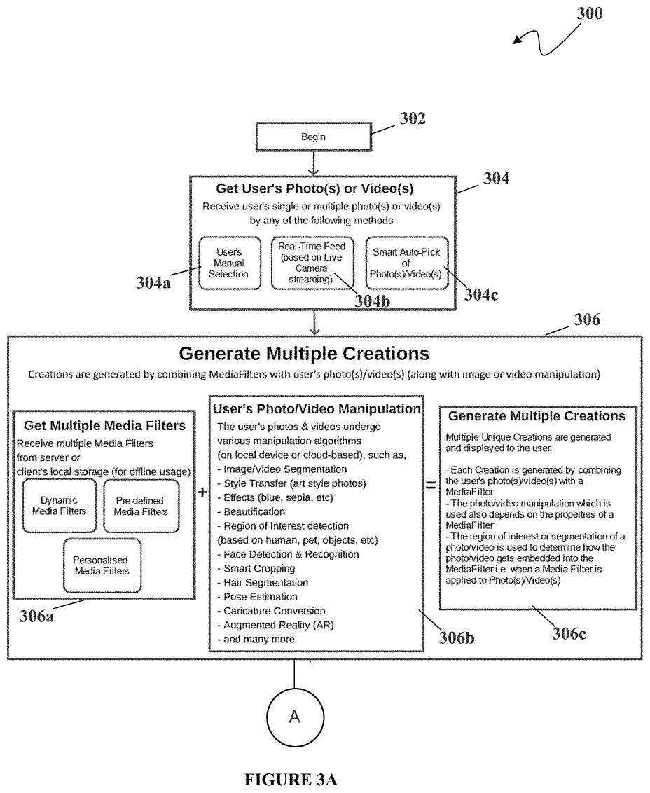

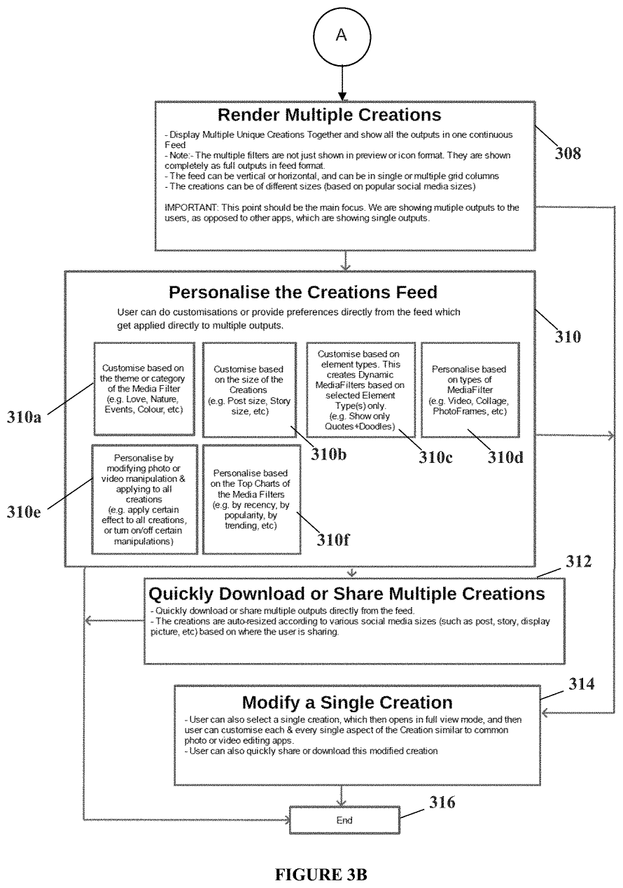

FIGS. 3A & 3B illustrate a schematic diagram depicting a workflow (300) of the system (100) for generating multiple media creations of FIG. 1, according to an exemplary implementation of the present invention.

The workflow (300) starts at a step (302) of FIG. 3A. At a step (304), getting user's photo(s) and video(s). In an embodiment, a selection module (108) is configured to receive user inputs and select at least one media content (for example user's photo(s) and video(s)) from one or more sources. In an embodiment, the selection module (108) selects the user's single or multiple media content by using methods, such as user's manual selection (304a) where the media content is/are manually selected by the user, a real-time feed based on live camera device streaming (304b), and/or by randomly selecting the media content from the various sources or automatically picking the media content from the sources (304c).

At a step (306), generating multiple creations. In an embodiment, the generation module (110) is configured to combine one or more pre-defined elements of media filters with the selected media content along with media content manipulation, and generate one or more creations.

At a step (306a), getting multiple media filters. In an embodiment, the filtering module (112) is configured to create a media filter based on one or more pre-defined elements stored in the database (122) or a combination of multiple elements of various types. The media filters can include dynamic media filters, pre-defined media filters, and personalized media filters.

At a step (306b), manipulating user's media content (for example, photos, videos, etc.). In an embodiment, the manipulation module (114) is configured to manipulate the selected media content by using at least one manipulation technique. The manipulation technique includes, but is not limited to, an image/video segmentation technique, a style transfer technique, Region of Interest (RoI) detection and smart cropping (based on human, pet, objects, etc.), face recognition, hair and costumes segmentation for color changing, image and video effects, beautification, pose estimation, caricature or cartoon creation, Augmented Reality (AR) technique, mirror effects, image cloning, face detection, face landmarks, face tracking, face attributes, AR sticker, face comparing, face searching, dense facial landmarks, facial landmark trigger, emotion recognition, beauty score, gaze estimation, three-dimensional face model reconstruction, human body recognition, body detection, skeleton detection, body outlining, body attributes, gesture recognition, face merging, text recognition, image recognition, photo album clustering, makeup, hairstyling, filters & effects, skin smoothing, face shaping, face swapping, expression recognition, face fun bulge, body reshaping, virtual avatar, video effects, morphing, virtual background, augmented beauty, face AI (Emotions & Attention; Gender, Age, Ethnicity; Identification), Try On, Blending, Cutout, PIP, Spiral/Swirls, Animation Stickers, Collage Creation, GIFs, Face Fit or Face Mask, image slicing, reflection/shadow, silhouette, doodle, sketch, face painting, or dispersion.

At a step (306c), generating multiple creations by combining the created filters and manipulated media content. In an embodiment, the creation module (116) is configured to embed the created media filter with the manipulated content, and can be further configured to create one or more creations of the selected media content. The multiple unique creations are then display to the user. In an embodiment, each creation is generated by combining the media content with a media filter. The media content manipulation which is used also depends on the properties of a media filter. The Region of Interest (RoI) or segmentation of a media content is used to determine how the media content gets embedded into the media filter, i.e. when the media filter is applied to the media content.

At a step (308) in FIG. 3B, rendering multiple creations. In an embodiment, the user device (102) can display multiple creations together and show all the outputs in one continuous feed. The multiple filters are not just shown in preview or icon format. The filters are shown completely as full outputs in a feed format. The feed can be vertical or horizontal, and can be in single or multiple grid columns. The creations can be different sizes.

At a step (310), personalizing the creations feed. In an embodiment, the personalization module (118) is configured to personalize the creations for the user based on the contextual data. In an embodiment, the personalization module (118) is configured to customize or provide preferences directly from the feed which get applied directly to multiple outputs. In an embodiment, the customization is based on the theme or category of the media filter (for example, Love, Nature, Events, Color, etc.) (310a), size of the creations (for example, post size, story size, etc.) (310b), element types, where dynamic media filters are created based on the selected element type(s) (for example, quotes, doodles, etc.) (310c); and personalize based on types of media filters (for example video, collage, photo frames, etc.) (310d), by modifying photo or video manipulation and applying to all creations (for example, applying certain effect to all creations, or turn ON/OFF certain manipulations) (310e), and based on top charts of the media filters (for example, by recency, popularity, trending, etc.) (310f).

At a step (312), quickly downloading or sharing multiple creations. In an embodiment, the user device (102) associated with the user can quickly download or share multiple outputs from the feed. In an embodiment, the creations are auto-resized according to various social media sizes (such as post, story, display picture, etc.) based on where the user is sharing.

At a step (314), modifying a single creation. In an embodiment, the user can also select a single creation, which then opens in a full view mode, and the user can customize each and every single aspect of the creation. The user can also quickly share or download the modified creation. At a step (316), the workflow (300) ends.

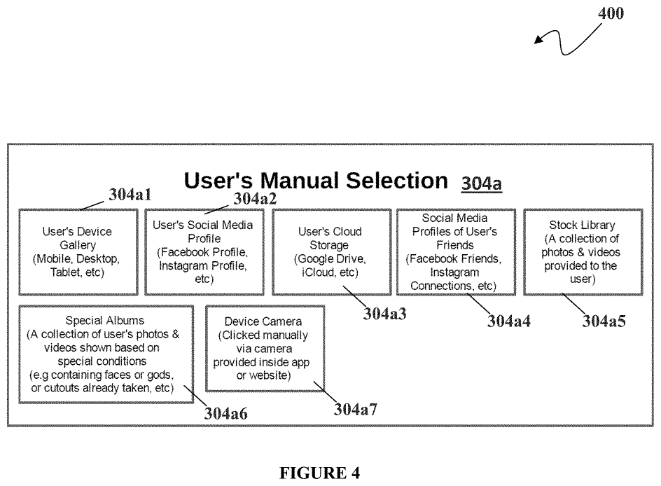

FIG. 4 illustrates a schematic diagram (400) depicting selection of media content, according to an exemplary implementation of the present invention.

In FIG. 4, the selection module (108) selects the user's single or multiple media content by using a method, such as user's manual selection (304a) where the media content is/are manually selected by the user. The media content can be selected the media content from, but are not limited to, a user's device gallery (304a1) (for example, mobile phone, desktop, tablet, etc.), user's social media profile (for example, Facebook® profile, Instagram® profile, etc.) (304a2), user's cloud storage (for example (Google® drive, Cloud, etc.) (304a3), social media profiles of user's friends (for example, Facebook® friends, Instagram® connections, etc.) (304a4), a stock library (304a5) where a collection of photos and videos provided to the user, special albums (304a6), where a collection of user's photos and videos are shown based on special conditions, e.g. containing faces or gods, or cutouts already taken, etc.), and a device camera (304a7) where a user can clicked manually media content via a camera).

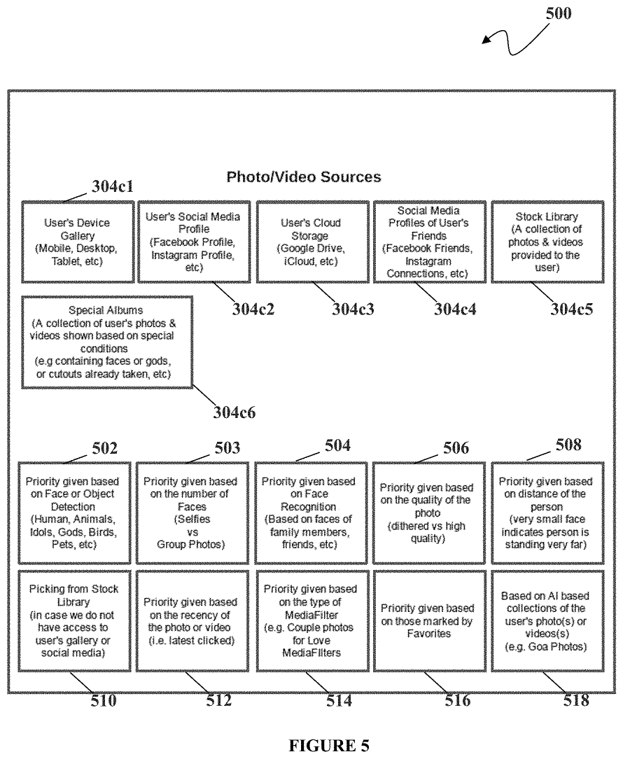

FIG. 5 illustrates a schematic diagram (500) depicting automatically selecting media content from one or more sources, according to an exemplary implementation of the present invention.

In FIG. 5, the selection module (108) can automatically selects media content from various sources, such as, but are not limited to, a user's device gallery (304c1) (for example, mobile phone, desktop, tablet, etc.), user's social media profile (for example, Facebook® profile, Instagram® profile, etc.) (304c2), user's cloud storage (for example (Google® drive, Cloud, etc.) (304c3), social media profiles of user's friends (for example, Facebook® friends, Instagram® connections, etc.) (304c4), a stock library (304c5) where a collection of photos and videos provided to the user, and special albums (304c6), where a collection of user's photos and videos are shown based on special conditions, e.g. containing faces or gods, or cutouts already taken, etc.). In an embodiment, the selection module (108) can automated media fetching algorithms, such as priority given based on face or object detection (for example, human, animals, idols, gods, birds, pets, etc.) (502), based on the number of faces (for example selfies, group photos, etc.) (503), based on face recognition (for example faces of family members, friends, etc.) (504), based on the quality of photos (dithered and high quality) (506), based on distance of the person (very small face indicates the user is standing very far) (508), picking from a stock library in a case where the system (100) has no access to the user's gallery or social media (510), priority given based on the recency of the photos or videos (i.e. latest clicked) (512), based on the type of media filter (for example couple photos for love media filter, etc.), based on those marked by Favorites (516), and based on AI based collections of the user's photos or videos (for example, any place photos) (518).

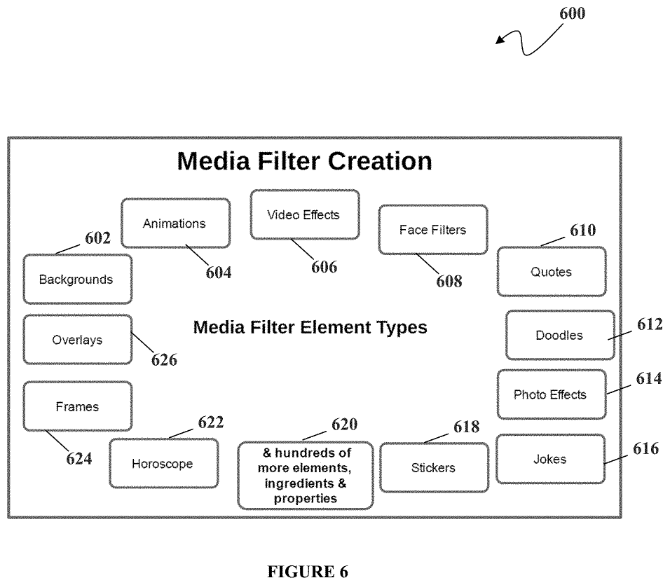

FIG. 6 illustrates a schematic diagram (600) depicting creation of media filter creation, according to an exemplary implementation of the present invention.

In an exemplary embodiment, the filtering module (112) is configured to create a media filter based on one or more pre-defined elements stored in the database (122) or on the media server (212), or a combination of multiple elements of various types. The media filter element types include, but are not limited to, backgrounds (602), animations (604), video effects and music (606), face filters (608), quotes and text (610), doodles (612), photo effects (614), jokes (616), stickers (618), horoscope (622), frames (624), and overlays (626), and other additional elements, ingredients, and properties (620).

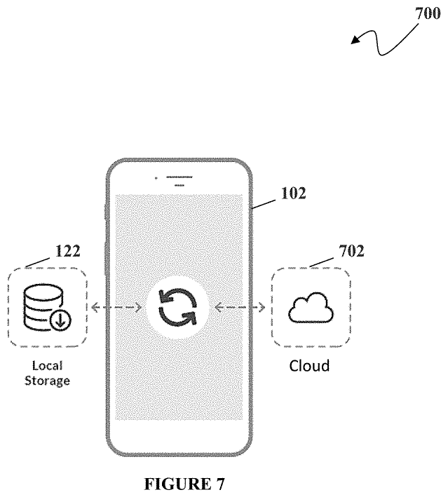

FIG. 7 illustrates a schematic diagram (700) depicting fetching of media filters, according to an exemplary implementation of the present disclosure. In FIG. 7, the user device (102) fetches the media filters from the local storage (122) or the database (122) or from a cloud (702). In an embodiment, the database (122) is configured to store pre-defined elements, automatic media filters, personalized media filters, user's media content, and a plurality of filters and effects. The pre-defined media filters are hand-crafted by combining the suitable elements of various types. This could also be used to create event based media filters (for example, Halloween, etc.). The automatic media filters are dynamically created by combining suitable elements of various types using a smart media filter generation technique. The technique creates the best media filters based on which elements look together. The personalized media filters are dynamically created based on user's preferences. This could be a manual choice provided by a user, or recommendation on basis of topics/categories they follow or based on their history of likes, favorites, shared, downloaded, etc., or based on photo/video analysis such as emotions, gender, people, animals, etc.

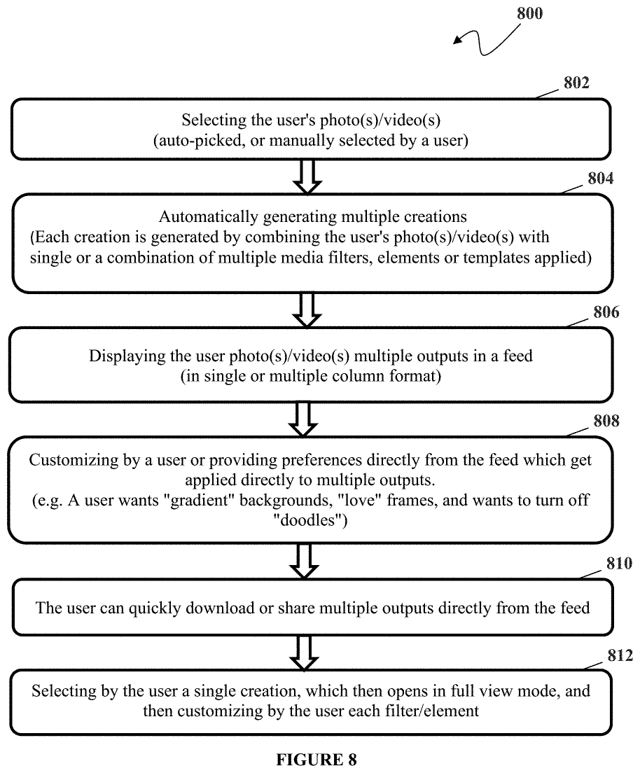

FIG. 8 illustrates a flow diagram (800) depicting an example for generating multiple media creations, according to an exemplary implementation of the present invention.

The flow diagram starts at a step (802), selecting the user's photos/videos by using auto-picked method or manually selection by a user. At a step (804), automatically generating multiple creations, where each creation is generated by combining the user's photos/videos with single or a combination of multiple media filters, elements or templates applied. At a step (806), displaying the user photo(s)/video(s) multiple outputs in a feed in single or multiple formats. At a step (808), customizing by the user or providing preference directly from the feed which get applied directly to multiple outputs. For example, a user wants “gradient background”, “love” frames”, and wants to turn off “doodles”. Thus, the system (100) is able to generate and display multiple variations of the same media content and present to the user. At a step (810), the user can quickly download or share multiple outputs directly from the feed. At a step (812), selecting by the user a single creation, which then opens in a full view mode, and then customizing by the user each filter element.

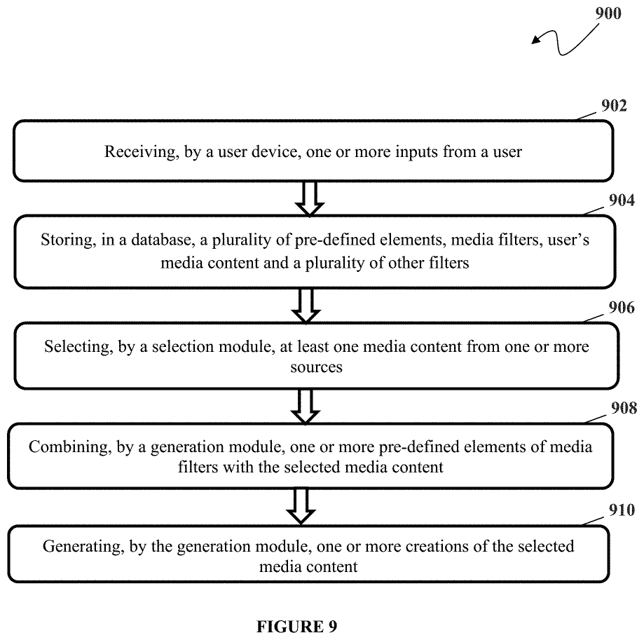

FIG. 9 illustrates a flow diagram depicting a method for generating multiple media creations, according to an exemplary implementation of the present invention.

The flow diagram (900) starts from a step (902), receiving, by a user device, one or more inputs from a user. In an embodiment, a user device (102) is configured to receive one or more inputs from a user. At a step (904), storing, in a database, a plurality of pre-defined elements, media filters, user's media content and a plurality of other filters. In an embodiment, a database (122) is configured to store a plurality of pre-defined elements, media filters, user's media content and a plurality of other filters. At a step (906), selecting, by a selection module, at least one media content from one or more sources. In an embodiment, a selection module (108) is configured to select at least one media content from one or more sources. At a step (908), combining, by a generation module, one or more pre-defined elements of media filters with said selected media content. In an embodiment, a generation module (110) is configured to combine one or more pre-defined elements of media filters with said selected media content. At a step (910), generating, by the generation module, one or more creations of the selected media content. In an embodiment, the generation module (110) is configured to generate one or more creations of the selected media content.

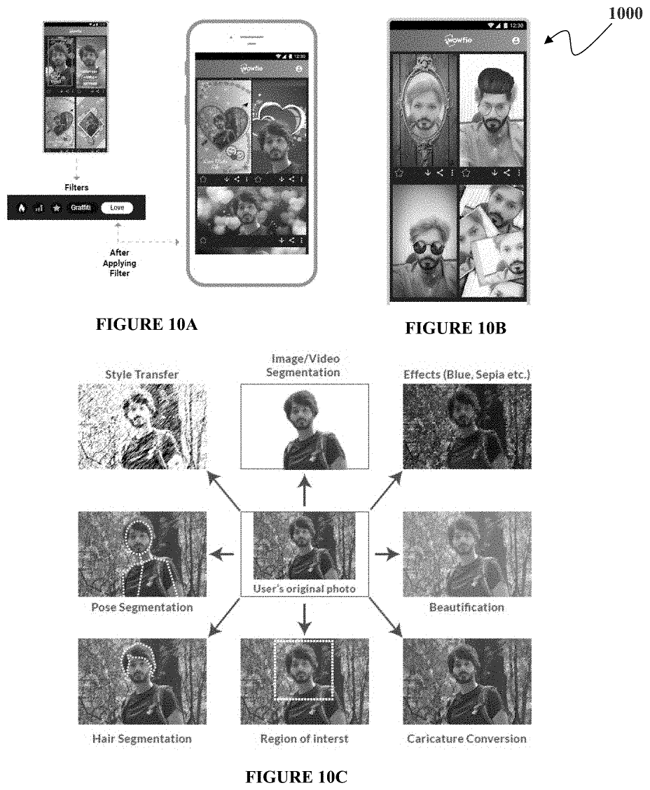

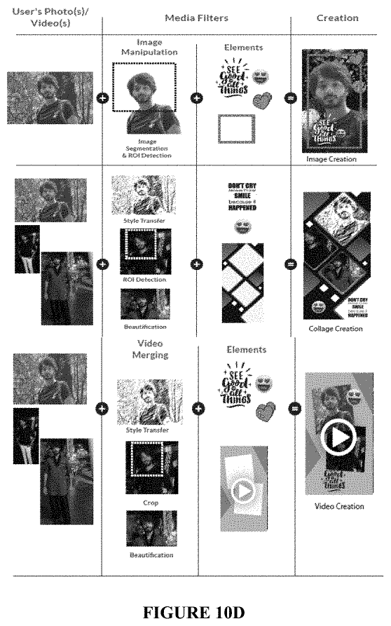

FIGS. 10a-10d illustrate use case scenarios depicting generating multiple media creations, according to an exemplary implementation of the present disclosure.

In FIG. 10a, the creations feed is personalized. A user can perform customization or provide preferences directly from the feed which get applied directly to multiple outputs. In FIG. 10b, the system (100) generates multiple filters outputs at a time. In FIG. 10c, photos/videos are manipulated. The user's photos/videos undergo various manipulation techniques, such as style transfer, image/video segmentation, effects, pose estimation, beautification, hair segmentation, RoI, caricature conversion, etc. In FIG. 10d, multiple creations are generated by combining media filters with user's photo(s)/video(s) along with image or video manipulation.

It should be noted that the description merely illustrates the principles of the present invention. It will thus be appreciated that those skilled in the art will be able to devise various arrangements that, although not explicitly described herein, embody the principles of the present invention. Furthermore, all examples recited herein are principally intended expressly to be only for explanatory purposes to help the reader in understanding the principles of the invention and the concepts contributed by the inventor(s) to furthering the art and are to be construed as being without limitation to such specifically recited examples and conditions. Moreover, all statements herein reciting principles, aspects, and embodiments of the invention, as well as specific examples thereof, are intended to encompass equivalents thereof.

Thus, having described the invention, what is claimed is:

1. A method for generating multiple media creations, said method comprising:
receiving, by a user device, one or more inputs from a user;
storing, in a database, a plurality of pre-defined elements, media filters, user's media content, and a plurality of other filters;
selecting, by a selection module, at least one media content from one or more sources;
combining, by a generation module, one or more pre-defined elements of media filters with said selected media content; and
generating, by said generation module, one or more creations of the selected media content.

2. The method as claimed in claim 1, wherein generating said one or more creations of the selected media content comprises:
creating, by a filtering module, a media filter based on one or more pre-defined elements or a combination of multiple elements of pre-determined types;
manipulating, by a manipulation module, the selected media content by using at least one manipulation technique;
embedding, by a creation module, the created media filter with the manipulated content; and
creating, by said creation module, one or more creations of the selected media content.

3. The method as claimed in claim 2, wherein creating said media filter comprises a step of generating an automatic media filter by combining suitable elements of various types using a media filter generation technique.

4. The method as claimed in claim 2, wherein creating said media filter comprises a step of generating a personalized media filter based on user's preference.

5. The method as claimed in claim 1 comprising: transmitting, by a communication module, the generated creations to the user device for displaying the generated creations as multiple outputs to the user.

6. The method as claimed in claim 1, comprising: personalizing, by a personalization module, the creations for the user based on the contextual data.

7. The method as claimed in claim 6, wherein the contextual data includes a theme or a category of the media filter, size of the creations, element types, types of media filters, manipulated media content, and popularity and trending.

8. The method as claimed in claim 1, wherein said one or more sources include public profiles of said user, social media websites, local storage of said user device.

9. The method as claimed in claim 1, wherein said media content includes images and videos.

10. A computer implemented system for generating multiple media creations, said system comprising:
a user device configured to receive one or more inputs from a user; and
a processing engine configured to cooperate with said user device, said processing engine comprising:
a database configured to store a plurality of pre-defined elements, media filters, user's media content and a plurality of other filters and effects;
a selection module configured to receive said inputs and select at least one media content from one or more sources; and
a generation module configured to cooperate with said selection module and said database, said generation module configured to combine one or more pre-defined elements of media filters with said selected media content, and generate one or more creations of the selected media content.

11. The system as claimed in claim 10, wherein said generation module comprises:
a filtering module configured to create a media filter based on one or more pre-defined elements stored in the database or a combination of multiple elements of pre-determined types;
a manipulation module configured to manipulate the selected media content by using at least one manipulation technique; and
a creation module configured to embed the created media filter with the manipulated content, and create one or more creations of the selected media content.

12. The system as claimed in claim 11, wherein said filtering module is configured to generate an automatic media filter by combining suitable elements of various types using a media filter generation technique.

13. The system as claimed in claim 11, wherein said filtering module is configured to generate a personalized media filter based on user's preference.

14. The system as claimed in claim 10, comprising: a communication module configured to transmit the generated creations to the user device to display the generated creations as multiple outputs to the user.

15. The system as claimed in claim 10, comprising: a personalization module configured to personalize the creations for the user based on the contextual data.

16. The method as claimed in claim 2 comprising: transmitting, by a communication module, the generated creations to the user device for displaying the generated creations as multiple outputs to the user.

17. The system as claimed in claim 11, comprising: a communication module configured to transmit the generated creations to the user device to display the generated creations as multiple outputs to the user.

18. A program storage device readable by a machine, tangibly embodying a program of instructions executable by the machine to perform the method steps for generating multiple media creations, said method steps comprising:
receiving, by a user device, one or more inputs from a user;
storing, in a database, a plurality of pre-defined elements, media filters, user's media content, and a plurality of other filters;
selecting, by a selection module, at least one media content from one or more sources;
combining, by a generation module, one or more pre-defined elements of media filters with said selected media content; and
generating, by said generation module, one or more creations of the selected media content;
wherein generating said one or more creations of the selected media content comprises:
creating, by a filtering module, a media filter based on one or more pre-defined elements or a combination of multiple elements of pre-determined types;
manipulating, by a manipulation module, the selected media content by using at least one manipulation technique;
embedding, by a creation module, the created media filter with the manipulated content; and
creating, by said creation module, one or more creations of the selected media content.
